(19) United States
(12) Patent Application Publication
(10) Pub. No.: US 2006/0154731 A1
(43) Pub. Date: Jul. 13, 2006

(54) Game chip

(75) Inventors: Toshimi Koyama, Tokyo (JP); Nobuyuki Nonaka, Tokyo (JP); Jituo Migita, Kami-gun (JP)

Correspondence Address: LEYDIG VOIT & MAYER, LTD, 700 THIRTEENTH ST. NW, SUITE 300, WASHINGTON, DC, 20005-3960, US

(73) Assignees: Aruze Corp., Tokyo (JP); Seta Corp., Tokyo (JP); MINERVA Corp., Kami-gun (JP)

(21) Appl. No.: 11/301,261

(22) Filed: Dec. 13, 2005

(30) Foreign Application Priority Data
Dec. 20, 2004 (JP) P2004-367241
Jan. 13, 2005 (JP) P2005-006076

(51) Int. Cl. A63F 13/00

(52) U.S. Cl. 463/43

(57) ABSTRACT

A game chip transmits information in response to an inquiry from a reader/writer. The game chip comprises an IC device, an antenna coil unit, a first ring and a second ring. The IC device constitutes an electromagnetic induction coupling circuit with the reader/writer and stores information. The antenna coil unit is connected to the IC device and generates an induced current by a magnetic flux emitted from the reader/writer to supply power to the IC device when the inquiry is received. The first ring induces the magnetic flux emitted from the reader/writer in one of directions of moving away from and approaching the reader/writer. The second ring induces the magnetic flux induced by the first ring in the other of the directions of moving away from and approaching the reader/writer.

### CROSS REFERENCE TO RELATED APPLICATION

This application claims benefit of priority under 35 U.S.C. §119 to Japanese Patent Application No. 2004-367241, filed on Dec. 20, 2004 and No. 2005-006076 filed on Jan. 13, 2005, the entire contents of which are incorporated by reference herein.

### BACKGROUND OF THE INVENTION

1. Field of the Invention

The present invention relates to a game chip, and more specifically to a game chip capable of being recognized by a reading device such as a reader/writer.

2. Description of the Related Art

There has conventionally been available a gaming machine that imitates a game in which a game table is employed and allows a player to make a bet without using real betting chips. The player inputs a betting target and the number of betting chips to the gaming machine by using buttons disposed on a control panel. However, the gaming machine has no function of permitting the player to directly put the betting chips on a game table, resulting in an impossibility of giving realistic sensation to the player during the game.

In order to solve the above problem, a gaming machine has been developed newly. The gaming machine enables a player to directly put betting chips in a predetermined area of the game table to make a bet. A roulette game, a card game (e.g. poker or black jack) and the like are cited as games installed in this gaming machine.

Conventional game chips (betting chips) are disclosed in Japanese Patent Application Laid-Open No. 2003-196634, No. 2003-85504 and No. 2004-21648. Each of these game chips incorporates an IC tag therein. The gaming machine recognizes the game chips and then reads the number of game chips with a reader/writer.

Generally, in a betting process, a player bets the desired number of game chips on a betting target (e.g. specific numeral, red/black, odd number/even number, or the like). More specifically, the player puts the desired number of game chips in a predetermined area (e.g. area to which numerals 1 to 36 each is assigned, area to which red or black is assigned, area to which an odd number or an even number is assigned, or the like) of the game table. In this case, the player must put the game chips in the predetermined area so that the reader/writer surely reads information stored in the IC tags of the game chips. When the number of game chips is large, the player must pile the game chips in a layer shape to put the game chips in the predetermined area.

However, piling the game chips in the layer shape causes an increase in distance between the reader/writer and the game chip of an upper layer. Therefore, when the reader/writer recognizes the game chips by an electromagnetic induction method, fluxes of magnetic lines (magnetic fluxes) emitted from the reader/writer are sufficiently diffused around before the magnetic fluxes reach the game chip of the upper layer. This causes a considerable reduction in the number of magnetic fluxes capable of reaching the game chip of the upper layer. In consequence, there is a possibility that the IC tag incorporated in the game chip of the upper layer will not reply to an inquiry from the reader/writer.

In order to enable the reader-writer to surely recognize the game chip of the upper layer by the electromagnetic induction method, the number of magnetic fluxes emitted from the reader/writer may be increased. However, the increase in the number of magnetic fluxes emitted from the reader/writer creates a problem that another game chip, to be recognized by another reader/writer, put in an area adjacent to the predetermined area is recognized by the reader/writer because of the diffused-around magnetic fluxes.

### SUMMARY OF THE INVENTION

It is an object of the present invention to provide game chips which enable a reading device to recognize a game chip of an upper layer in a state of piling the game chips in a layer shape.

It is another object of the present invention to provide game chips which can prevent a reading device from recognizing another game chip located in one of radial directions of the game chips in a state of piling the game chips in a layer shape when the number of magnetic fluxes emitted from the reading device is increased.

In order to achieve the object, the present invention provides a game chip configured to transmit information in response to an inquiry from a reading device, comprising: a circuit unit configured to store the information and constitute an electromagnetic induction coupling circuit with the reading device; an antenna unit connected to the circuit unit and configured to generate an induced current by a magnetic flux emitted from the reading device to supply power to the circuit unit when the inquiry is received, and to emit a magnetic flux carrying the information to the reading device when the information is transmitted; a first magnetic flux induction unit configured to induce the magnetic flux emitted from the reading device in one of directions of moving away from and approaching the reading device; and a second magnetic flux induction unit configured to induce the magnetic flux induced by the first magnetic flux induction unit in the other of the directions of moving away from and approaching the reading device.

According to the present invention, in a state where the game chips are stacked in layers, magnetic fluxes are guided to the first or second magnetic flux induction unit of each game chip to reach a game chip located in an upper layer without being diffused around. Accordingly, without greatly reducing the number of magnetic fluxes, the magnetic fluxes can reach the game chip located in the upper layer.

Moreover, in the state where the game chips are stacked in layers, when the magnetic fluxes cross the game chip located in the upper layer to be discharged into an atmosphere, the magnetic fluxes are guided to the first or second magnetic flux induction unit of each game chip without being diffused around, to return to its radiation source (reading device). Accordingly, even if the number of magnetic fluxes emitted from the reading device is increased so that the reading device surely recognizes the game chip of the upper layer by an electromagnetic induction method, it is possible to prevent the reading device from recognizing another game chip, to be read by another reading device, located in one of radial directions of the game chips

### BRIEF DESCRIPTION OF THE DRAWINGS

FIG. 1 is a perspective diagram of a gaming machine according to an embodiment of the present invention.

FIG. 2 is a functional block diagram of the gaming machine according to the embodiment of the present invention.

FIG. 3A is a perspective diagram of a game chip according to the embodiment of the present invention.

FIG. 3B is a sectional diagram along the line IIIB-IIIB of FIG. 3A.

FIG. 3C is a sectional diagram along the line IIIC-IIIC of FIG. 3B.

FIG. 4 is a diagram showing magnetic fluxes emitted from a reader/writer when the reader/writer reads information from one game chip according to the embodiment of the present invention.

FIG. 5 is a diagram showing magnetic fluxes emitted from the reader/writer when the reader/writer reads information from a plurality of game chips according to the embodiment of the present invention;

FIG. 6A is a perspective diagram of a game chip according to a modified example of the embodiment of the present invention.

FIG. 6B is a sectional diagram along the line VIB-VIB of FIG. 6A.

FIG. 6C is a sectional diagram alone the line VIC-VIC of FIG. 6B.

FIG. 7 is a diagram showing magnetic fluxes emitted from the reader/writer when the reader/writer reads information from one game chip according to the modified example of the embodiment of the present invention.

FIG. 8 is a diagram showing magnetic fluxes emitted from the reader/writher when the reader/writer reads information from a plurality of game chips according to the modified example of the present invention.

### DESCRIPTION OF THE PREFERRED EMBODIMENTS

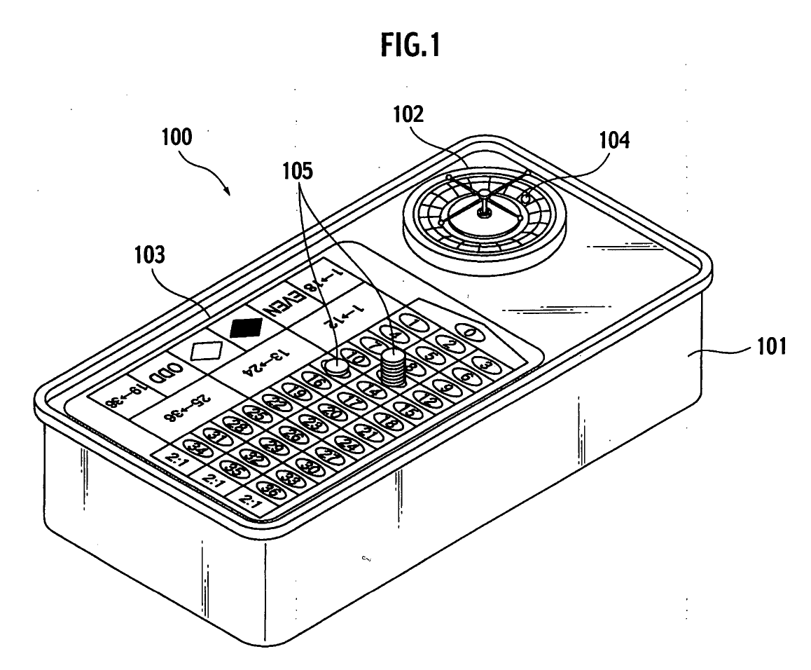

Hereinafter, the preferred embodiments of the present invention will be described with reference to FIGS. 1 to 8.

(1. Gaming Machine)

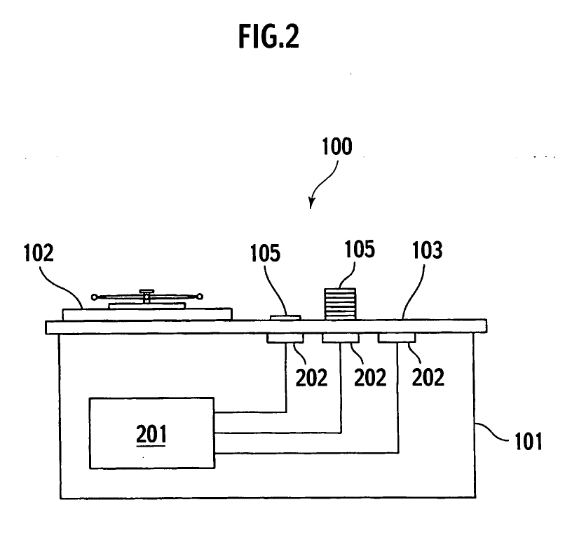

A gaming machine 100 is an apparatus which enables a player, to play a roulette game. As shown in FIGS. 1 and 2, the gaming machine 100 comprises a main body 101, a wheel 102, a layout 103, a ball 104, a plurality of game chips 105, a main control device 201 and a plurality of readers/writers 202.

The main body 101 is formed in to a table shape. The wheel 102 has pockets corresponding to numerals “0” to “36” colored red or black, and is disposed on an upper surface of the main body 101. The layout 103 has betting targets (betting areas) corresponding to numerals/colors of “1→18”, “19→36”, “1→12”, “13→24”, “25→36”, “0” to “36”, “red”, “black”, “odd number” and “even number”, and is disposed on the upper surface of the main body 101. The ball 104 is stored in the wheel 102. The game chip 105 is a tool which is employed to indicate a betting target and an amount of values (e.g. cash, credits or points) bet on the betting target. The game chip 105 is put at one of the betting targets arrayed in the layout 103 in a betting process of the roulette game.

The main control device 201 controls a progress of the roulette game, and is arranged in the main body 101. The reader/writer 202 reads information (ID information in this embodiment) stored in an IC device of the game chip 105, and is arranged in the main body 101 so as to be opposed to one of the betting targets of the layout 103. The reader/writer 202 reads information stored in the IC device of the game chip 105 put on a related betting target, and transmits the read information to the main control device 201. The ID information is information for identifying an attribute of the game chip 105. Based on the ID information, the main control device 201 recognizes a player who owns the game chip 105 and a value of the game chip 105 corresponding to the ID information.

The reader/writer 202 does not need to have a function of both reading and writing, but only needs to have at least a function of reading information stored in the IC device of the game chip 105. The information stored in the IC device of the game chip 105 is not limited to the ID information. Any information can be employed as long as it enables the main control device 201 to recognize the player who owns the game chip 105 and the value of the game chip 105. For example, player ID information and chip value information (value of 1 coin, value of 10 coins, value of 100 coins or the like) may be separately stored in the game chip. By storing the player ID information, it is possible to prevent pretense of being a player. It is noted that terminal ID information may be substituted for the player ID information when a player terminal is employed in the roulette game.

In the betting process of the roulette game, the player predicts a pocket of the wheel 102 in which the rotating ball 104 will be held, and puts one or more game chips 105 on one or more betting targets arrayed in the layout 103 based on a numeral/color corresponding to the predicted pocket. After one or more game chips 105 have been put in the layout 103, each reader/writer 202 reads information from the IC device of each game chip 105, and transmits the read information to the main control device 201. The main control device 201 recognizes one or more betting targets indicated by the player and a value of each game chip 105 and the number of game chips 105 put on each betting target by the player based on the received information.

Upon recognition that the player has made a bet, the main control device 201 rotates the ball 104 in the wheel 102. Then, the main control device 201 detects a pocket which has held the ball 104 via a sensor (not shown) disposed in the wheel 102 to determine whether or not the pocket predicted by the player matches the pocket holding the ball 104. If matched, the main control device 201 adds a dividend to player's game account stored therein in accordance with odds and the value of each game chip 105 and the number of game chips 105 put on the winning betting target, and displays the dividend and a total amount on a payout display (not shown).

(2-1. Game Chip)

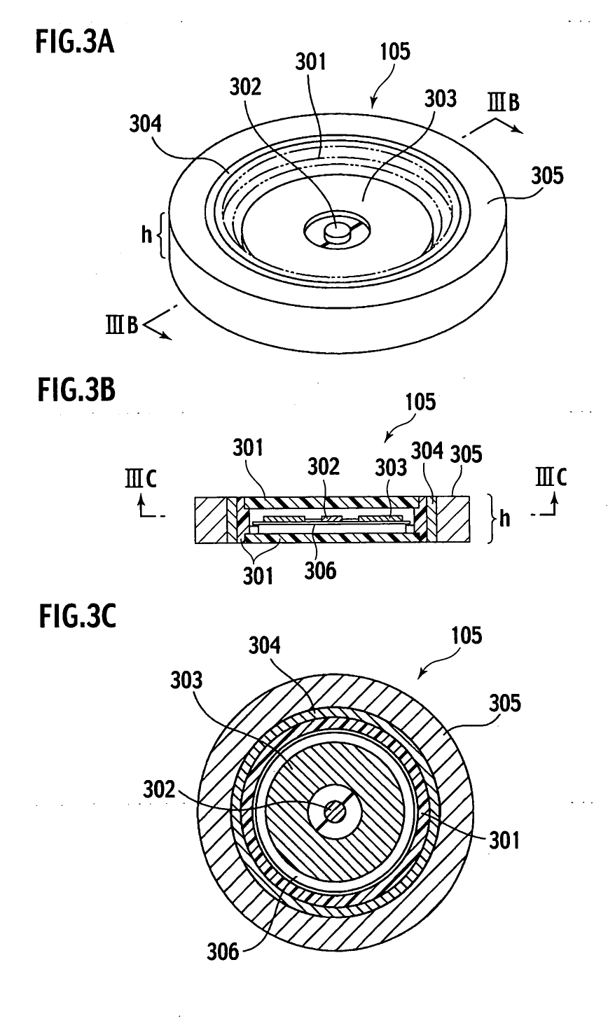

As shown in FIGS. 3A to 3C, the game chip 105 comprises a main body 301, an IC device (circuit unit) 302, an antenna coil unit (antenna unit) 303, a first ring (first magnetic flux induction unit) 304, a second ring (second magnetic flux induction unit) 305 and a substrate 306. The main body 301 is made of a resin or the like, and is provided with an annular upper plate, a disk lower plate and a cylindrical side plate. The main body 301 houses the IC device 302, the antenna coil unit 303 and the substrate 306. The substrate 306 is formed into a disk shape, and arranged on an upper surface of the lower plate of the main body 301. The substrate 306 is coaxial to the main body 301.

The IC device 302 is formed into a columned shape, and arranged in a center of the substrate 306 to be coaxial to the substrate 306. The IC device 302 is an electronic component for executing a processing function, a storing function and an input/output control function, and transmits information stored therein to the reader/writer 202 in response to an inquiry from the reader/writer 202.

The antenna coil unit 303 is formed into an annular shape, and arranged in a peripheral edge of the substrate 306 so as to surround the IC device 302 to be coaxial to the IC device 302. The antenna coil unit 303 is connected to the IC device 302 to support transfer of information between the reader/writer 202 and the IC device 302. The IC device 302 does not need any battery because the IC device 302 transmits/receives information by using a current induced at the antennal coil unit 303 by fluxes of magnetic lines (magnetic fluxes) emitted from the reader/writer 202.

The first ring 304 is formed into an cylindrical shape, and fitted to the main body 301 so as to surround an outer peripheral surface of the main body 301 to be coaxial to the main body 301. The first ring 304 is made of a diamagnetic or perfect diamagnetic material. The first ring 304 cancels magnetic fluxes diffused around to guide the magnetic fluxes to a hollow part thereof in which the main body 301 is arranged.

The second ring 305 is formed into a cylindrical shape, and is fitted to the first ring 304 so as to surround an outer peripheral surface of the first ring 304 to be coaxial to the first ring 304. The second ring 305 is made of a material of high relative magnetic permeability (e.g. iron or ferrite). Generally, a magnetic flux has a nature of gathering on a material of high relative magnetic permeability. Accordingly, the second ring 305 captures magnetic fluxes to prevent the magnetic fluxes from leaking to the outside of the game chip 105. By arranging the second ring 305 in a peripheral border of the game chip 105, the reader/writer 202 does not read information of another game chip, to be read by another reader/writer, arranged in an area adjacent to the predetermined area. The relative magnetic permeability of the second ring 305 only needs to be higher than that of the main body 301 which has housed the IC device 302 and the antennal coil unit 303. The second ring 305 has a height h almost equal to that of the first ring 304.

The shapes of the first and second rings 304 and 305 are not limited to the cylindrical shapes. Any shapes are allowed as long as the first and second rings 304 and 305 come into contact with parts of adjacent first and second rings 304 and 305 in an up-and-down direction, respectively, in a state where the game chips 105 are stacked in layers. Spaces may be formed between the main body 301 and the first ring 304 and/or between the first and second rings 304 and 305.

(3-1. Information Reading)

First, a mechanism by which the reader/writer 202 reads information of one game chip 105 will be described.

The reader/writer 202 generates a carrier wave (AC signal) belonging to a 135 kHz band or a 13.56 MHz band, and modulates the carrier wave and amplifies power based on a base band signal corresponding to transmit data. Then, upon supplying of the carrier wave to an antenna (loop coil) 202a of the reader/writer 202, magnetic fluxes 401 are emitted from a hollow part of the antenna 202a.

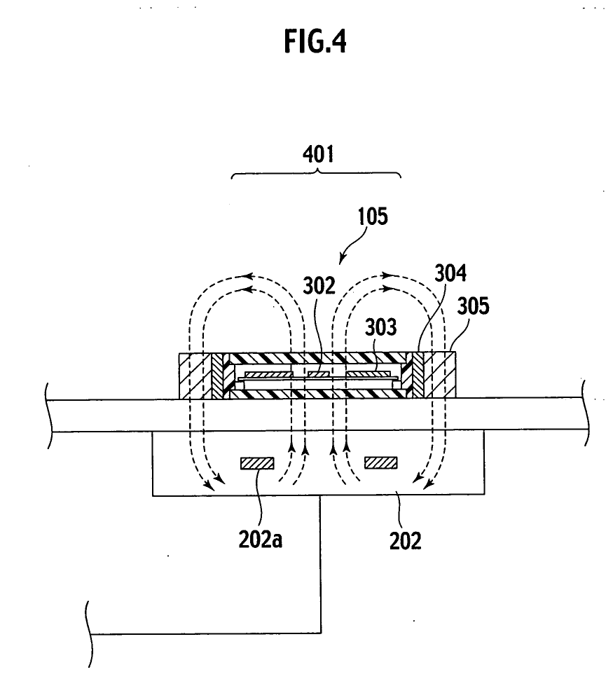

At the antenna 202a, when a current flows in a counterclockwise direction viewed from the upper surface of the main body 101, the magnetic fluxes 401 are radiated upward with respect to the antenna 202a by a corkscrew rule. The radiated magnetic fluxes 401 are guided by the first ring 304 from the lower side of the first ring 304 to the hollow part of the first ring 304 without being diffused around, to be discharged into an atmosphere. The discharged magnetic fluxes 401 are captured by the second ring 305 to be guided to the hollow part of the antenna 202a of the reader/writer 202 (see FIG. 4).

At the antenna 202a, when a current flows in a clockwise direction viewed from the upper surface of the main body 101, the magnetic fluxes 401 are radiated downward with respect to the antenna 202a by a corkscrew rule. The radiated magnetic fluxes 401 are captured by the second ring 305 to be discharged into an atmosphere. The discharged magnetic fluxes 401 are guided by the first ring 304 from the upper side of the first ring 304 to the hollow part of the first ring 304 without being diffused around, to return to the hollow part of the antenna 202a of the reader/writer 202.

When the magnetic fluxes 401 cross the hollow part of the antenna coil unit 303, a current is induced at the antenna coil unit 303 by electromagnetic induction, and then power is supplied to the IC device 302. Thus, the game chip 105 and the reader/writer 202 constitute an electromagnetic induction coupling circuit. When the induced current is supplied to the IC device 302, the game chip 105 transmits information stored in the IC device 302 to the reader/writer 202 by using load modulation.

Next, a mechanism by which the reader/writer 202 reads information of a plurality of game chips 105 (five game chips in this embodiment) stacked in layers will be described.

The reader/writer 202 generates a carrier wave (AC signal) belonging to a 135 kHz band or a 13.56 MHz band, and modulates the carrier wave and amplifies power based on a base band signal corresponding to transmit data. Then, upon supplying of the carrier wave to the antenna (loop coil) 202a of the reader/writer 202, the magnetic fluxes 401 are emitted from the hollow part of the antenna 202a.

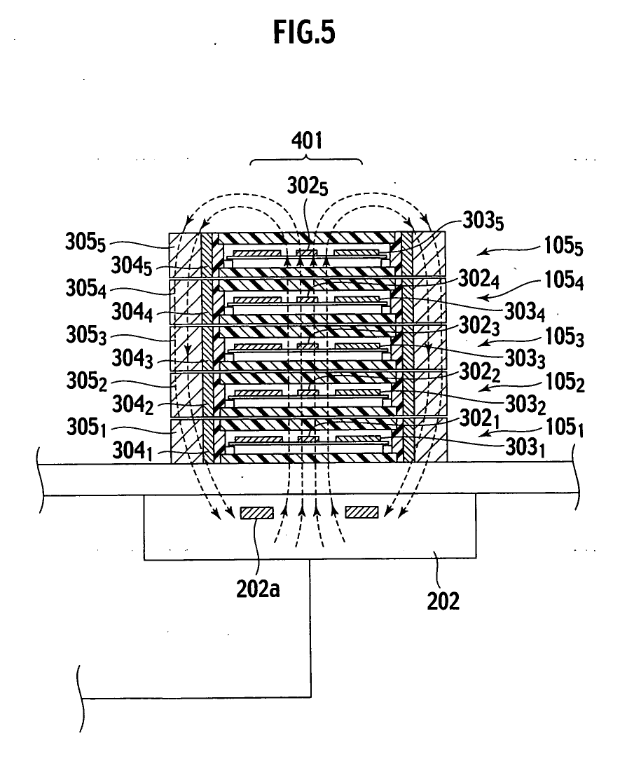

At the antenna 202a, when a current flows in a counterclockwise direction viewed from the upper surface of the main body 101, the magnetic fluxes 401 are radiated upward with respect to the antenna 202a by a corkscrew rule (see FIG. 5). The radiated magnetic fluxes 401 are guided by a first ring 304₁ of a game chip 105₁ located in a lower layer from a lower side of the first ring 304₁ to a hollow part of the first ring 304₁. Then, the magnetic fluxes 401 are guided by first rings 304₂, 304₃, 30₄ and 304₅ without being diffused around, to be discharged into an atmosphere. The discharged magnetic fluxes 401 are captured by a second ring 305₅ of a game chip 1055 located in an upper layer. Then, the magnetic fluxes 401 pass through second rings 305₄, 305₃, 305₂ and 305₁ to be guided to the hollow part of the antenna 202a of the reader/writer 202.

At the antenna 202a, when a current flows in a clockwise direction viewed from the upper surface of the main body 101, the magnetic fluxes 401 are radiated downward with respect to the antenna 202a by a corkscrew rule. The radiated magnetic fluxes 401 are captured by the second ring 305₁ of the game chip 105₁ located in the lower layer. Then, the magnetic fluxes 401 pass through the second rings 305₂, 305₃, 305₄ and 305₅ to be discharged into an atmosphere. The discharged magnetic fluxes 401 are guided by the first ring 304₅ of the game chip 105₅ located in the upper layer from the upper side of the first ring 304₅ to the hollow part of the first ring 304₅. Then, the magnetic fluxes 401 are guided by the first rings 304₄, 304₃, 304₂ and 304₁ without being diffused around, to return to the hollow part of the antenna 202a of the reader/writer 202.

When the magnetic fluxes 401 cross the hollow part of the antenna coil unit 303ᵢ of the game chip 105ᵢ (1≦i≦5), a current is induced at the antenna coil unit 303ᵢ by electromagnetic induction, and then power is supplied to the IC device 302ᵢ. Then, the game chip 105ᵢ transmits information stored in the IC device 302ᵢ to the reader/writer 202 by using load modulation.

Advantageous features of the game chip 105 will be described.

In a state where the game chips 105 are stacked in layers, the magnetic fluxes 401 are guided to the first or second ring 304 or 305 of each game chip 105 to reach the game chip 105 located in the upper layer without being diffused around. Accordingly, without greatly reducing the number of magnetic fluxes, the magnetic fluxes 401 can reach the game chip 105 located in the upper layer.

In the state where the game chips 105 are stacked in layers, when the magnetic fluxes 401 cross the game chip 105 located in the upper layer to be discharged into an atmosphere, the magnetic fluxes 401 are guided to the first or second ring 304 or 305 of each game chip 105 without being diffused around, to return to its radiation source (hollow part of the antenna 202a). Accordingly, even if the number of magnetic fluxes emitted from the reader/writer is increased so that the reader/writer surely recognizes the game chip of the upper layer by the electromagnetic induction method, it is possible to prevent the reader/writer from recognizing another game chip, to be read by another reader/writer, set in the area adjacent to the predetermined area.

Next, a modified example of a game chip will be described.

(2-2. Game Chip)

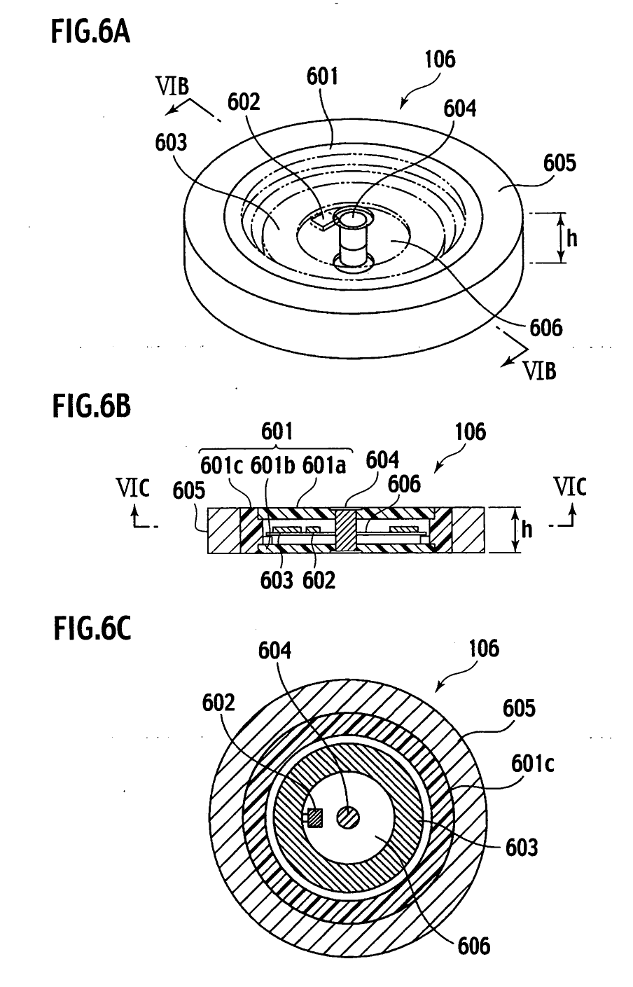

As shown in FIGS. 6A to 6C, a game chip 106 comprises a main body 601, an IC device (circuit unit) 602, an antenna coil unit (antenna unit) 603, a column member (first magnetic flux induction unit) 604, a ring member (second magnetic flux induction unit) 605 and a substrate 606. The main body 601 is made of a resin or the like, and is provided with an annular upper plate 601a, an annular lower plate 601b and a cylindrical side plate 601c. The upper and lower plates 601a and 601b are stuck to both ends of the side plate 601c. The main body 601 houses the IC device 602, the antenna coil unit 603, the column member 604 and the substrate 606. The substrate 606 is formed into an annular shape, and arranged on an upper surface of the lower plate 601b of the main body 601. The substrate 606 is coaxial to the main body 601.

The IC device 602 is formed into a square column shape, and arranged in the vicinity of a center of the substrate 606. The IC device 602 is an electronic component for executing a processing function, a storing function and an input/output control function, and transmits information stored therein to a reader/writer 202 in response to an inquiry from the reader/writer 202.

The antenna coil unit 603 is formed into an annular shape, and arranged in a peripheral edge of the substrate 606 so as to surround the IC device 602 to be coaxial to the main device 601. The antenna coil unit 603 is connected to the IC device 602 to support transfer of information between the reader/writer 202 and the IC device 602. The IC device 602 does not need any battery because the IC device 602 transmits/receives information by using a current induced at the antennal coil unit 603 by fluxes of magnetic lines (magnetic fluxes) emitted from the reader/writer 202.

The column member 604 is fitted to hollow parts of the upper and lower plates 601a and 601b of the main body 601 so as to penetrate the center of the main body 601 to be coaxial to the main body 601. The column member 604 is made of a material of high relative magnetic permeability. The column member 604 captures magnetic fluxes crossing the main body 601 to prevent the magnetic fluxes from leaking to the outside of the game chip 106.

The ring member 605 is fitted to the main body 601 so as to surround an outer peripheral surface of the side plate 601c of the main body 601 to be coaxial to the main body 601. The ring member 605 is made of a material of high relative magnetic permeability (e.g. iron or permalloy). The ring member 605 captures magnetic fluxes to prevent the magnetic fluxes from leaking to the outside of the game chip 106. By arranging the ring member 605 in the outside of the column member 604, the reader/writer 202 does not read information of another game chip, to be read by another reader/writer, arranged in an area adjacent to the predetermined area. The relative magnetic permeability of the ring member 605 only needs to be higher than that of the main body 601 which has housed the IC device 602 and the antennal coil unit 603. The ring member 605 has a height h almost equal to that of the column member 604.

With this configuration, when the game chips 106 are stacked in layers, the column member 604 and the ring member 605 come into contact with an adjacent column member 604 and an adjacent ring member 605 in an up-and-down direction, respectively. As a result, two paths made of materials having high relative magnetic permeability are formed in the game chip layer.

(3-2. Information Reading)

First, a mechanism by which the reader/writer 202 reads information of one game chip 106 will be described.

The reader/writer 202 generates a carrier wave (AC signal) belonging to a 135 kHz band or a 13.56 MHz band, and modulates the carrier wave and amplifies power based on a base band signal corresponding to transmit data. Then, upon supplying of the carrier wave to an antenna (loop coil) 202a of the reader/writer 202, magnetic fluxes 401 is emitted from a hollow part of the antenna 202a.

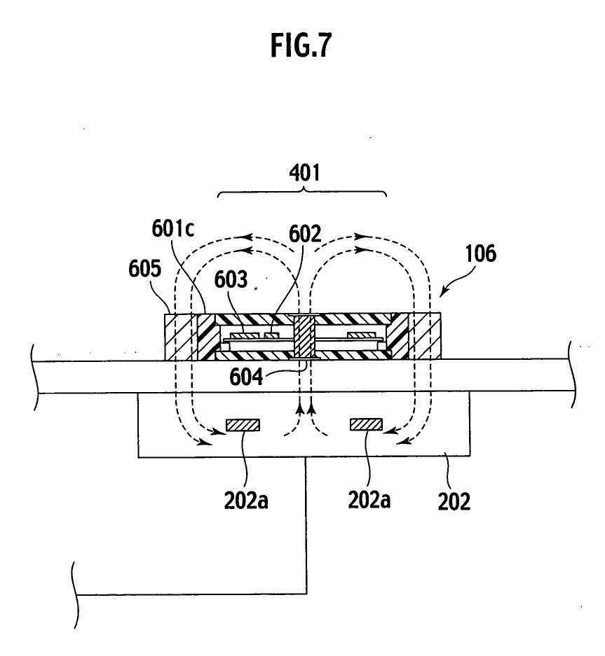

At the antenna 202a, when a current flows in a counterclockwise direction viewed from the upper surface of the main body 601, the magnetic fluxes 401 are radiated upward with respect to the antenna 202a by a corkscrew rule. The radiated magnetic fluxes 401 are captured by the column member 604 from the lower side of the column member 604 to be discharged into an atmosphere. The discharged magnetic fluxes 401 are captured by the ring member 605 to be guided to the hollow part of the antenna 202a of the reader/writer 202 (see FIG. 7).

At the antenna 202a, when a current flows in a clockwise direction viewed from the upper surface of the main body 601, the magnetic fluxes 401 are radiated downward with respect to the antenna 202a by a corkscrew rule. The radiated magnetic fluxes 401 are captured by the ring member 605 to be discharged into an atmosphere. The discharged magnetic fluxes 401 are captured by the column member 604 from the upper side of the column member 604 without being diffused around, to be guided to the hollow part of the antenna 202a of the reader/writer 202.

When the magnetic fluxes 401 cross the hollow part of the antenna coil unit 603, a current is induced at the antenna coil unit 603 by electromagnetic induction, and then power is supplied to the IC device 602. Thus, the game chip 106 and the reader/writer 202 constitute an electromagnetic induction coupling circuit. When the induced current is supplied to the IC device 602, the game chip 106 transmits information stored in the IC device 602 to the reader/writer 202 by using load modulation.

Next, a mechanism by which the reader/writer 202 reads information of a plurality of game chips 106 (five game chips in this embodiment) stacked in layers will be described.

The reader/writer 202 generates a carrier wave (AC signal) belonging to a 135 kHz band or a 13.56 MHz band, and modulates the carrier wave and amplifies power based on a base band signal corresponding to transmit data. Then, upon supplying of the carrier wave to the antenna (loop coil) 202a of the reader/writer 202, the magnetic fluxes 401 are emitted from the hollow part of the antenna 202a.

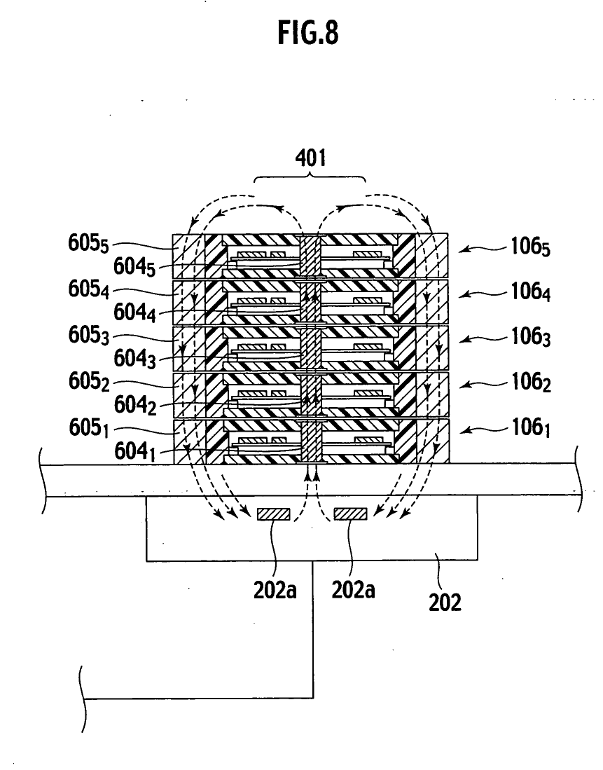

At the antenna 202a, when a current flows in a counterclockwise direction viewed from the upper surface of the main body 601, the magnetic fluxes 401 are radiated upward with respect to the antenna 202a by a corkscrew rule (see FIG. 8). The radiated magnetic fluxes 401 are captured by a column member 604₁ of a game chip 106₁ located in a lower layer from a lower side of the column member 604₁. Then, the magnetic fluxes 401 pass through column members 604₂, 604₃, 604₄ and 604₅ without being diffused around, to be discharged into an atmosphere. The discharged magnetic fluxes 401 are captured by a ring member 605₅ of a game chip 106₅ located in an upper layer. Then, the magnetic fluxes 401 pass through ring members 605₄, 605₃, 605₂ and 605₁ to be guided to the hollow part of the antenna 202a of the reader/writer 202.

At the antenna 202a, when a current flows in a clockwise direction viewed from the upper surface of the main body 601, the magnetic fluxes 401 are radiated downward with respect to the antenna 202a by a corkscrew rule. The radiated magnetic fluxes 401 are captured by the ring member 605₁ of the game chip 106₁ located in the lower layer. The magnetic fluxes 401 pass through the ring members 605₂, 605₃, 605₄ and 605₅ to be discharged into an atmosphere. The discharged magnetic fluxes 401 are captured by the column member 604₅ of the game chip 106₅ located in the upper layer from the upper side of the column member 604₅. Then, the magnetic fluxes 401 pass through the column members 604₄, 604₃, 604₂ and 604₁ without being diffused around, to be guided to the hollow part of the antenna 202a of the reader/writer 202.

When the magnetic fluxes 401 cross the hollow part of the antenna coil unit 603ᵢ of the game chip 106ᵢ (1≦i≦5), a current is induced at the antenna coil unit 603ᵢ by electromagnetic induction, and then power is supplied to the IC device 602ᵢ. Then, the game chip 106ᵢ transmits information stored in the IC device 602ᵢ to the reader/writer 202 by using load modulation.

Advantageous features of the game chip 106 will be described.

In a state where the game chips 106 are stacked in layers, the magnetic fluxes 401 are guided to the column member 604 or the ring member 605 of each game chip 106 to reach the game chip 106 located in the upper layer without being diffused around. Accordingly, without greatly reducing the number of magnetic fluxes, the magnetic fluxes 401 can reach the game chip 106 located in the upper layer.

In the state where the game chips 106 are stacked in layers, when the magnetic fluxes 401 cross the game chip 106 located in the upper layer to be discharged into an atmosphere, the magnetic fluxes 401 are guided to the column member 604 or the ring member 605 of each game chip 106 without being diffused around, to return to its radiation source (hollow part of the antenna 202a). Accordingly, even if the number of magnetic fluxes emitted from the reader/writer is increased so that the reader/writer surely recognizes the game chip of the upper layer by the electromagnetic induction method, it is possible to prevent the reader/writer from recognizing another game chip, to be read by another reader/writer, set in the area adjacent to the predetermined area.

What is claimed is:

1. A game chip configured to transmit information in response to an inquiry from a reading device, comprising:
a circuit unit configured to store the information and constitute an electromagnetic induction coupling circuit with the reading device;
an antenna unit connected to the circuit unit and configured to generate an induced current by a magnetic flux emitted from the reading device to supply power to the circuit unit when the inquiry is received, and to emit a magnetic flux carrying the information to the reading device when the information is transmitted;
a first magnetic flux induction unit configured to induce the magnetic flux emitted from the reading device in one of directions of moving away from and approaching the reading device; and
a second magnetic flux induction unit configured to induce the magnetic flux induced by the first magnetic flux induction unit in the other of the directions of moving away from and approaching the reading device.

2. The game chip according to claim 1, wherein the first magnetic flux induction unit is made of a diamagnetic material and surrounds the antenna unit.

3. The game chip according to claim 2, wherein the second magnetic flux induction unit is made of a material of high relative magnetic permeability and surrounds the first magnetic flux induction unit.

4. The game chip according to claim 3, wherein the first and second magnetic flux induction units come into contact with parts of those of an adjacent game chip, respectively, in a state where a plurality of game chips are stacked in layers.

5. The game chip according to claim 4, wherein the first and second magnetic flux induction units are substantially equal to each other in height.

6. The game chip according to claim 1, further comprising a main body configured to house the circuit unit and the antenna unit.

7. The game chip according to claim 6, wherein the first magnetic flux induction unit is made of a diamagnetic material and surrounds the main body.

8. The game chip according to claim 7, wherein the second magnetic flux induction unit is made of a material of high relative magnetic permeability and surrounds the first magnetic flux induction unit.

9. The game chip according to claim 8, wherein the first and second magnetic flux induction units come into contact with parts of those of an adjacent game chip, respectively, in a state where a plurality of game chips are stacked in layers.

10. The game chip according to claim 9, wherein the first and second magnetic flux induction units are substantially equal to each other in height.

11. The game chip according to claim 1, wherein:
the circuit unit is formed into a columned shape;
the antenna unit is formed into an annular shape and surrounds the circuit unit;
the first magnetic flux induction unit is formed into a cylindrical shape and surrounds the antenna unit; and
the second magnetic flux induction unit is formed into a cylindrical shape and surrounds the first magnetic flux induction unit.

12. The game chip according to claim 11, wherein the circuit unit, the antenna unit and the first and second magnetic flux induction units are coaxial to one another.

13. The game chip according to claim 11, wherein the directions of moving away from and approaching the reading device are an axial direction of the first and second magnetic flux induction units.

14. The game chip according to claim 1, wherein the first magnetic flux induction unit is made of a material of high relative magnetic permeability and penetrates a hollow portion of the antenna unit.

15. The game chip according to claim 14, wherein the second magnetic flux induction unit is made of a material of high relative magnetic permeability and surrounds the antenna unit.

16. The game chip according to claim 15, wherein the first and second magnetic flux induction units come into contact with parts of those of an adjacent game chip, respectively, in a state where a plurality of game chips are stacked in layers.

17. The game chip according to claim 16, wherein the first and second magnetic flux induction units are substantially equal to each other in height.

18. The game chip according to claim 6, wherein the first magnetic flux induction unit is made of a material of high relative magnetic permeability and penetrates a hollow portion of the main body.

19. The game chip according to claim 18, wherein the second magnetic flux induction unit is made of a material of high relative magnetic permeability and surrounds the main body.

20. The game chip according to claim 19, wherein the first and second magnetic flux induction units come into contact with parts of those of an adjacent game chip, respectively, in a state where a plurality of game chips are stacked in layers.

21. The game chip according to claim 20, wherein the first and second magnetic flux induction units are substantially equal to each other in height.

22. The game chip according to claim 1, wherein:
the first magnetic flux induction unit is formed into a columned shape;
the antenna unit is formed into an annular shape and surrounds the circuit unit and the first magnetic flux induction unit; and
the second magnetic flux induction unit is formed into a cylindrical shape and surrounds the antenna unit.

23. The game chip according to claim 22, wherein the first magnetic flux induction unit, the antenna unit and the second magnetic flux induction unit are coaxial to one another.

24. The game chip according to claim 22, wherein the directions of moving away from and approaching the reading device are an axial direction of the first and second magnetic flux induction units.
